(19) United States
(12) Patent Application Publication
(10) Pub. No.: US 2019/0311386 A1
(43) Pub. Date: Oct. 10, 2019

(54) METHOD AND SYSTEM FOR INCENTIVIZING CHARITABLE CONTRIBUTIONS

(71) Applicant: YOU AND 2, LLC, Washington, DC (US)

(72) Inventor: Marc Steven BARNES, Washington, DC (US)

(73) Assignee: YOU AND 2, LLC, Washington, DC (US)

(21) Appl. No.: 16/375,016

(22) Filed: Apr. 4, 2019

Related U.S. Application Data
(60) Provisional application No. 62/652,562, filed on Apr. 4, 2018.

(51) Int. Cl. G06Q 30/02; G06Q 20/08; G06F 3/0484

(52) U.S. Cl. CPC G06Q 30/0209; G06Q 20/085; G06F 3/04842; G06Q 30/0214; G06F 3/04847; G06Q 30/0279

(57) ABSTRACT

A method for gamification of charitable contributions on a computing platform includes: storing, in a memory of a computing device, program code for an application program executable by a processor of the computing device; receiving at least a selection of a charitable cause, a contribution amount, and payment information from a user of the computing device; transmitting the selection of the charitable cause, the contribution amount, and the payment information to a processing server; receiving contribution data from the processing server, the contribution data including at least a direct contribution amount and a referred contribution amount associated with the user of the computing device; generating a graphical illustration of the received contribution data; and displaying, by a display device interfaced with the computing device, the generated graphical illustration.

### FIELD

The present disclosure relates to the use of an application program in a computing device that includes specially configured features to incentivize users to provide contributions to charitable causes and encourage referrals and further participation to increase the amount of charitable funding.

### BACKGROUND

Fundraising isn't easy in the real world. It can be overwhelming for the average donor and make them feel like they need to donate larger and larger amounts of money to fewer numbers of charitable organizations in order to make any kind of lasting impact. Many organizations seek to provide incentives to donors in order to encourage donations, as a way to offset the overwhelming nature of donations in present times. Such organizations typically offer unique experiences, such as with celebrities, or gifts or rewards based on the amount of donation. However, these incentives are only beneficial if the potential donor has an interest in that experience or gift, and often require significant donations to be worthwhile to the donor, exacerbating the problem detailed above.

Thus, there is a need for a tool that allows donors to do the exact opposite, to make minimal contributions to a vast number of organizations, and, through scale, become part of a movement of like-minded people who, together, begin to change the world. A technical implementation of such a tool may provide for stronger incentives that can still incentivize and encourage contributions, even in small amounts, through gamification and networking.

### SUMMARY

The present disclosure provides a description of systems and methods for gamification of charitable contributions on a computing platform. An application program on a computing device collects charitable donation information for a cause from a user, as well as referring information. The user is encouraged to make a donation, no matter how small, and refer at least two others to do the same. As the referrals continue, the individual's overall impact can be significantly increased, despite the small donation. The donor's impact is graphically illustrated on the computing device, taking into account the overall contribution provided through referrals, so that they can easily understand the impact that they had, even with such a small donation. The illustration serves as a way of gamifying their charitable contribution, encouraging participation for every user, and incentivizing every level of donation.

A method for gamification of charitable contributions on a computing platform includes: storing, in a memory of a computing device, program code for an application program executable by a processor of the computing device; receiving, by an input device interfaced with the computing device, at least a selection of a charitable cause, a contribution amount, and payment information from a user of the computing device; transmitting, by a transmitter of the computing device, the selection of the charitable cause, the contribution amount, and the payment information to a processing server; receiving, by a receiver of the computing device, contribution data from the processing server, the contribution data including at least a direct contribution amount and a referred contribution amount associated with the user of the computing device; generating, by the processor of the computing device, a graphical illustration of the received contribution data; and displaying, by a display device interfaced with the computing device, the generated graphical illustration.

A non-transitory computer readable media in a computing device is configured to store program code executable by a processor of the computing device, wherein execution of the program code by the processor causes the computing device to perform a method for gamification of charitable contributions, and where the method includes: receiving, by an input device interfaced with the computing device, at least a selection of a charitable cause, a contribution amount, and payment information from a user of the computing device; transmitting, by a transmitter of the computing device, the selection of the charitable cause, the contribution amount, and the payment information to a processing server; receiving, by a receiver of the computing device, contribution data from the processing server, the contribution data including at least a direct contribution amount and a referred contribution amount associated with the user of the computing device; generating, by the processor of the computing device, a graphical illustration of the received contribution data; and displaying, by a display device interfaced with the computing device, the generated graphical illustration.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for the gamification of charitable contributions in accordance with exemplary embodiments.

FIG. 2 is a block diagram illustrating a system architecture of the computing device of FIG. 1 for the gamification of charitable contributions in accordance with exemplary embodiments.

FIGS. 3A and 3B are a flow diagram illustrating a process for gamification of charitable contributions in the system of FIG. 1 in accordance with exemplary embodiments.

FIG. 4 is a flow diagram illustrating an exemplary method for gamification of charitable contributions on a computing platform in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Gamification of Charitable Contributions

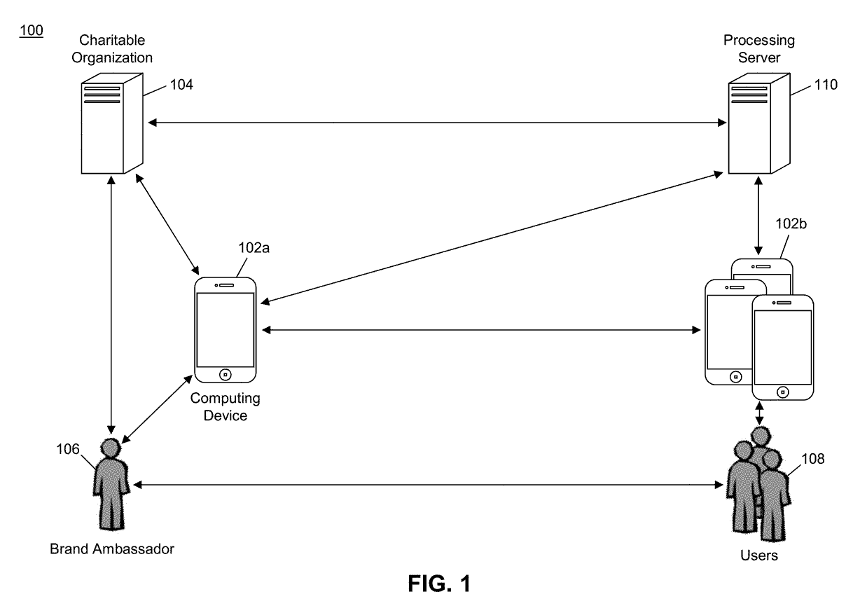

FIG. 1 illustrates a system 100 for the gamification of charitable contributions, where a graphical illustration is used to provide an incentive for charitable contributions of any size, and to encourage referrals and networking to further increase the overall contribution for each donor to a charitable cause.

The system 100 may include a computing device 102. The computing device 102, discussed in more detail below, may provide a computing platform to a user to enable the user to make a donation to a charitable cause and to provide a platform for gamification of the donation and overall contribution to the charitable cause. In the system 100, a charitable organization 104 may have a charitable cause that they want to collect donations for through computing platforms provided by computing devices 102. The charitable organization 104 may reach out to one or more brand ambassadors 106 for outreach on behalf of the charitable cause. Each brand ambassador 106 may have their own computing device 102a which they use to interact with the computing platform, such as through an application program stored in or otherwise accessible by the computing device 102a and executed thereby. Brand ambassadors 106 may be influential leaders that can quickly amass a group of followers, which may encourage participation by the followers at a higher level than an average person. Brand ambassadors 106 may be, for instance, individuals, corporations, celebrities, sports teams, influencers, etc.

Each brand ambassador 106 may reach out to their followers and encourage each to make a small contribution to the charitable cause, such as encouraging every attendee at a concert to donate $1 to the charitable cause using the computing platform. Each of the followers may be a user 108 in the system 100, which may use their own computing device 102b to access the computing platform and make a donation to the charitable cause. Each of the users 108 may be encouraged, by both the brand ambassador 106 and the computing platform, to, in addition to their contribution, ask two other users 108, such as their friends, family members, coworkers, etc., to match their contribution or make any amount of contribution. These referred users 108 may then make their own contributions, and ask two additional users 108 to make contributions. If users 108 continue to refer other users, the tree of contributing users 108 may grow exponentially, enabling small contributions to have a significant impact to the charitable cause.

The computing platform may be designed to encourage users 108 to participate in contributing and referring other users 108 through gamification. Gamification may be implemented through a combination of real-time rewards and graphical representations of their overall contribution effected by their personal contribution and the contributions of users 108 referred directly by themselves as well as indirectly referred (e.g., referred by their referred users 108, and referred by those users 108, and so on).

When a user 108 makes a donation using the computing platform, a processing server 110 may track their donation. For instance, the user 108 may select the charitable cause on the computing platform using their computing device 102, their preferred method of donation (e.g., credit card, debit card, wire transfer, or other financial payment service), the amount of their donation, and any referral information to provide, such as the name, code, or other identifier of another user 108 or brand ambassador 106 that referred them to make the donation. The processing server 110 may receive the information, process the donation using the appropriate financial service (e.g., a payment network for credit or debit transactions, the selected financial payment service, the clearing house for wire transfers, etc.), and store information regarding the user 108 and their donation. For instance, each user 108 in the computing platform may have a unique identifier associated therewith, such as an identification number, telephone number, e-mail address, usemame, etc., which may be used to track donations, referrals, and other interactions with the computing platform. In instances where the user's donation may be their first ever donation, the user 108 may be assigned their unique identifier, or may include their desired unique identifier when submitting their donation.

The processing server 110 may accordingly track all donations made by users 108 for a charitable cause, as well as the fundraising tree that includes the user 108 based on if their donation was a result of a referral by another user 108 or brand ambassador 106 and any donations resulting from their own referral. In some cases, the processing server 110 may facilitate referrals by providing the user 108 (e.g., directly following their charitable contribution, or through the computing platform on the computing device 102) with a uniform resource locator or other type of interactable element that can be provided to referred users 108. For example, the application program for the computing platform may enable a user 108 to transmit short messaging service or multimedia messaging service messages to other users 108 that include a link that, when interacted with by the other user 108, opens the application program and auto-fills referral information for the user 108, the charitable cause, and the donation amount may be the user 108. In another example, the user 108 may be referred to a social network or provided assistance in submitting a post to a selected social network to encourage followers and others connected to the user 108 in the social network to donate to the charitable cause. For instance, the computing platform may provide a template post for Facebook® or tweet for Twitter® that includes the charitable cause, amount, and/or other information that may be selected by the user 108 or charitable organization 104 to encourage followers to also donate. In such instances, the post may include a link that is interactable to take the referred user 108 to the computing platform to make the same or a greater donation to the same charitable cause, where the initial user's unique identifier may be included. Such methods may facilitate donations by the referred users 108, as well as encourage the referred users 108 to refer additional users 108, and keep the fundraising tree growing.

As contributions are received and the data associated therewith stored in the processing server 110, each user 108 may be able to view a graphical representation of their contribution using the computing platform on the computing device 102. A user 108 may execute the application program for the computing platform on their computing device 102 and select to view information regarding their contribution. The computing platform may request the real-time data regarding their overall contribution from the processing server 110, which may identify the user's direct contribution (e.g., using their unique identifier) as well as the contributions by the user's direct referrals and any referrals therefrom, any of their referrals, and so on. The computing device 102 may receive the data and may generate a graphical illustration that is then displayed to the user 108 using the computing device 102. In one example, the graphical illustration may be a tree, where the tree may grow in size as the overall contribution attributed to the user 108 is increased (e.g., as indirect or direct referrals continue to be made and contributions received from such users 108). In some cases, the tree may be animated to grow up to a size based on their overall contribution each time the representation is accessed.

In some cases, the processing server 110 and/or computing device 102 may determine a contribution level for the user 108. The contribution level may be based on their overall contribution amount, which may be based on their own contribution and any contribution attributed thereto as a result of direct and indirect referrals. In some cases, the contribution level may be based on the monetary amount of the overall contribution (e.g., levels at every $1,000 contributed). In some instances, the contribution level may also be based on the overall amount received for the charitable cause (e.g., levels for each percentage point of the overall amount attributable to the user 108). In some cases, the contribution levels may be set by the charitable organization 104. In embodiments where contribution levels are identified, the graphical representation may include the contribution level, such as displayed as part of the graphical representation or where the representation itself is based on the contribution level. For instance, in the above example, the size of the tree may be a result of the contribution level, the tree may display the contribution level, the type of tree may be based on the contribution level, etc. In another example, the graphical illustration may be a stadium where the crowd fills up as the level or contribution amount increases. The overall improvement and growth of the graphical representation and contribution level may provide gamification to the users 108 and encourage further participation through direct contributions, direct referrals, and indirect referrals. The computing platform may also utilize any additional gamification techniques that may be suitable, such as displaying leaderboards for contribution levels, number of referrals, overall contribution amounts, combined amounts and/or levels across multiple charitable causes, etc.

In some instances, a contribution level may be based on information related to a user 108 in addition to, or in alternative to, the user's contribution amount and referred contribution amount. For instance, the contribution level may be based on the amount of users 108 that were directly and/or indirectly referred by the user 108. In some such cases, referred users may be assigned points or other value, where the more direct the referral is, the greater the assigned value (e.g., a direct referred or a referral once removed may be worth more than a referred user 108 that is several referrals away). In some cases, the contribution level may be based on a combination of the number of referred users and their respective contribution amounts, which may also utilize weighting based on the distance of the referral. In another example, the contribution level may be based on how quickly the initial user 108 gains referred users 108. For instance, the charitable organization 104, processing server 110, and/or computing platform may set goals where contribution levels are based on how quickly the initial user 108 reaches predetermined numbers of referrals and/or a contribution amount from the number of referrals. In some embodiments, a user 108 may have multiple contribution levels, such as a level for overall contribution amount, a level for number of referred users, and a level based on the average contribution made by the user's referrals.

In some embodiments, users 108 may be provided with rewards based on their contribution data. For instance, rewards may be distributed to users 108 on the computing platform as their overall contribution amount or contribution level increases, such as additional features or benefits in the computing platform itself (e.g., badges, cosmetics, trophies, exclusive accessible areas, etc.) as well as physical or virtual items that may be provided to the user 108. For example, the charitable organization 104 may have gifts that are distributed to users 108 when their overall contribution amount hits one or more milestones, such as medals, trophies, plaques, certificates, t-shirts, posters, figurines, etc.

The systems and methods discussed herein may incentivize users to make donations to charitable causes regardless of the size of the donation. The gamification provided by the computing platform in the computing devices 102, which incentivizes referrals and overall contributions, encourages donations of any amount to be made, and can encourage and reward users 108 to make referrals for such donations. By strongly encouraging and rewarding overall contributions, the amount raised for a charitable cause can be significant, even when each user 108 only makes a small donation, because of the networking and fundraising tree that is encouraged through the graphical representation and gamification system provided by the computing platform. The result is a fundraising system that incentivizes participation at any level, and can therefore reach a greater audience than platforms that focus on large rewards and experiences, which may be specific to only a small number of users 108 and only encourage donations of significant amounts.

### Computing Device

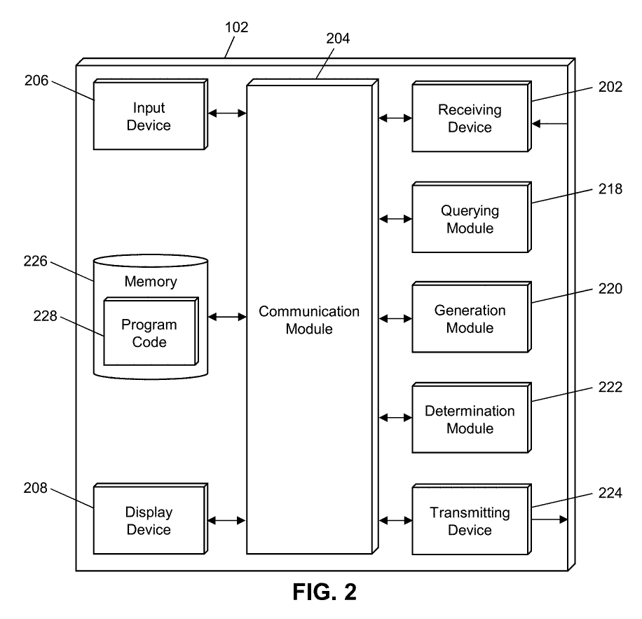

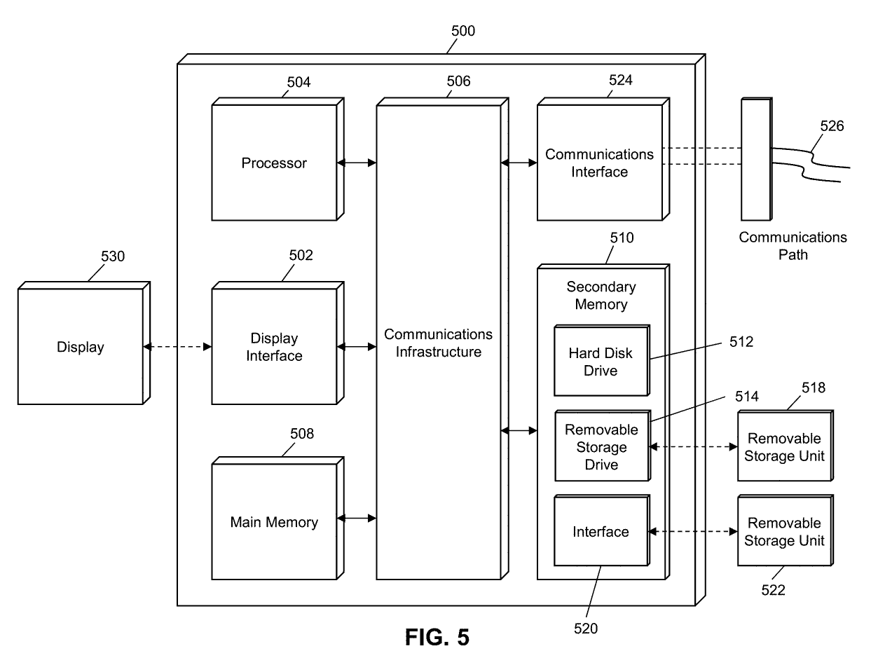

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 500 illustrated in FIG. 5 and discussed in more detail below may be a suitable configuration of the computing device 102. The implementation of the computing device 102 illustrated in FIG. 2 and discussed below may also be suitable as an implementation of the processing server 102 illustrated in the system 100 and discussed above.

The computing device 102 may include a receiving device 202. The receiving device 202 may be configured to receive data over one or more networks via one or more network protocols. In some instances, the receiving device 202 may be configured to receive data from charitable organizations 104, processing servers 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by charitable organizations 104 that are superimposed or otherwise encoded with charitable cause information, reward data, and other data regarding charitable causes and collection of donations therefor. The receiving device 202 may also be configured to receive data signals electronically transmitted by processing servers 110, which may be superimposed or otherwise encoded with contribution data including contribution levels, direct contribution amounts, referred contribution amounts, total contribution amounts, reward data, fundraising trees, referral numbers, charitable cause data, etc.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, determination module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include or be otherwise interfaced with one or more input devices 206. The input devices 206 may be internal to the computing device 102 or external to the computing device 102 and connected thereto via one or more connections (e.g., wired or wireless) for the transmission of data to and/or from. The input devices 206 may be configured to receive input from a user of the computing device 102, which may be provided to another module or engine of the computing device 102 (e.g., via the communication module 204) for processing accordingly. Input devices 206 may include any type of input device suitable for receiving input for the performing of the functions discussed herein, such as a keyboard, mouse, click wheel, scroll wheel, microphone, touch screen, track pad, camera, optical imager, etc. The input device 206 may be configured to, for example, receive information from a user 108 regarding selection of a charitable cause, a donation amount, information for referrals to other users 108 and/or computing devices 102, referral information for their own donation, requests for graphical illustrations, shipping information for rewards, etc.

The computing device 102 may also include or be otherwise interfaced with a display device 208. The display device 208 may be internal to the computing device 102 or external to the computing device 102 and connected thereto via one or more connections (e.g., wired or wireless) for the transmission of data to and/or from. The display device 208 may be configured to display data to a user of the computing device 102. The display device 208 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 208. The display device 208 may be configured to, for example, display prompts to the user 108 for selection of charitable causes, gathering of donations, making referrals to other users 108, etc., and to display graphical illustrations of contributions and contribution levels for the user 108 based on contribution data received from processing servers 110.

The computing device 102 may include a querying module 218. The querying module 218 may be configured to execute queries on databases to identify information. The querying module 218 may receive one or more data values or query strings, and may execute a query string based thereon on an indicated database, such as a memory 226, to identify information stored therein. The querying module 218 may then output the identified information to an appropriate engine or module of the computing device 102 as necessary. The querying module 226 may, for example, execute a query on the memory 226 to identify information for communicating with a processing server 110 or to identify received and stored contribution data.

The computing device 102 may also include a generation module 220. The generation module 220 may be configured to generate data for use by the computing device 102 in performing the functions discussed herein. The generation module 220 may receive instructions as input, may generate data based on the instructions, and may output the generated data to one or more modules of the computing device 102. For example, the generation module 220 may be configured to generate graphical illustrations of contributions made by the user 108 for charitable causes, which may be generated and/or updated in real-time as contribution data is updated in the computing device 102. The generation module 220 may also be configured to generate short messaging service messages, e-mail messages, and other data messages for transmission to other computing devices 102 for referrals.

The computing device 102 may also include a determination module 222. The determination module 222 may be configured to make determinations for the computing device 102 as part of the functions discussed herein. The determination module 222 may receive an instruction as input, may make a determination based on that instruction, and may output a result of the determination to another module or engine of the computing device 102. The determination module 222 may, for example, be configured to determine contribution levels for a user 108 for charitable causes based on direct and indirect contribution amounts and total contributions for a charitable cause, which may be further or alternatively based on criteria set for the charitable cause, such as by the associated charitable organization 104.

The computing device 102 may also include a transmitting device 224. The transmitting device 224 may be configured to transmit data over one or more networks via one or more network protocols. In some instances, the transmitting device 224 may be configured to transmit data to other computing devices 102, charitable organizations 104, processing servers 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to other computing devices 102 that are superimposed or otherwise encoded with referral information, such as at least a unique identifier associated with the computing device 102 and/or user 108 that is used to track that a subsequent contribution to a charitable cause was referred to by the user 108, and may be further included with charitable cause information, donation information, and any other data as discussed herein. The transmitting device 224 may also be configured to electronically transmit data signals to charitable organizations 104 that may be superimposed or otherwise encoded with donation information, such as a contribution amount, payment information, financial service information, etc., as discussed herein. The transmitting device 224 may also be configured to electronically transmit data signals to processing servers 110, which may be superimposed or otherwise encoded with donation information, referring information, requests for contribution levels and/or contribution data, or other data as discussed herein.

The computing device 102 may also include a memory 226. The memory 226 may be configured to store data for use by the computing device 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store program code 228 executable by a processor of the computing device 102 for performing the functions discussed herein, such as the computing platform discussed above, as well as the querying module 218, generation module 220, determination module 222, etc.

### Process for Incentivizing Charitable Contributions

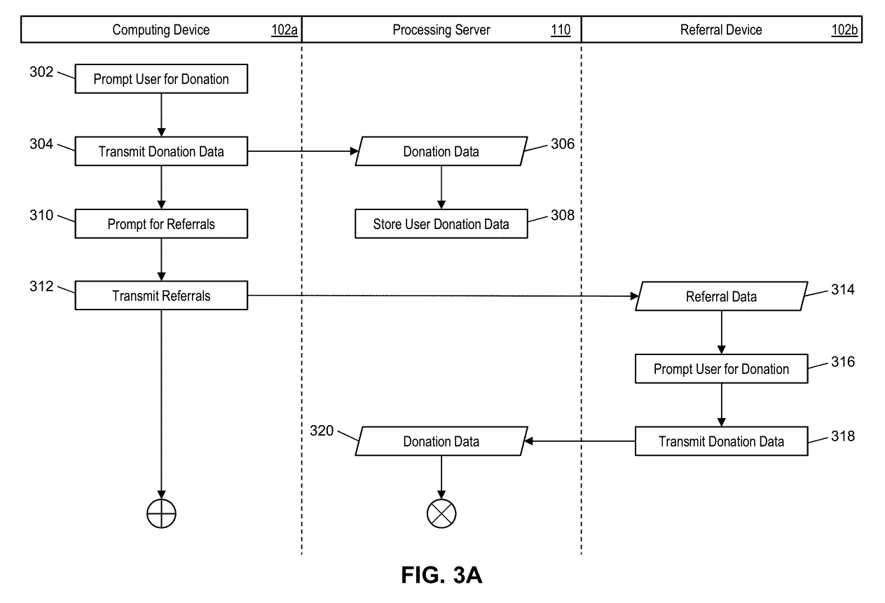

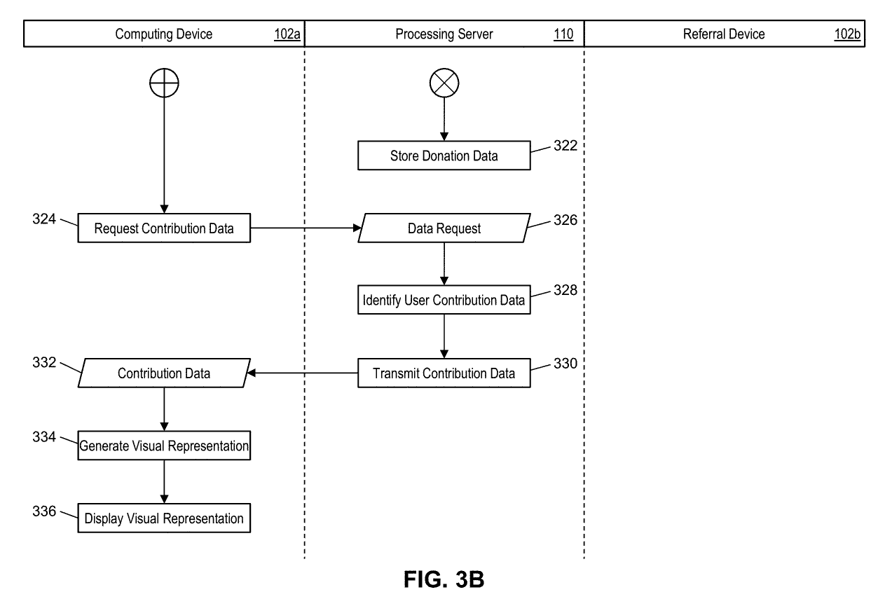

FIGS. 3A and 3B illustrate a process for the incentivizing of charitable contributions in the system 100 of FIG. 1 through the gamification of contributions on the computing platform of the computing devices 102.

In step 302, a brand ambassador 106 or user 108 of the computing device 102a may be prompted to select a charitable cause and make a donation thereto using the computing platform executed by a processor of the computing device 102a. The computing device 102a may collect, such as via the input device 206 thereof, the selection of the charitable cause and the donation amount, as well as any data necessary for payment of the donation itself, from the user 108. In step 304, the transmitting device 224 of the computing device 102a may electronically transmit the donation data to the processing server 110. In step 306, the processing server 110 may receive the donation data, which may include the charitable cause, donation amount, payment information, and a unique identifier associated with the user 108 and/or computing device 102a. In step 308, the processing server 110 may process the donation, such as by submitting the payment information to a suitable financial service for payment to the charitable organization 104 indicated by the selected charitable cause, and may store information regarding the user's donation in a database or other storage.

In step 310, the display device 208 of the computing device 102a may prompt the user 108 to input (e.g., via the input device 206) information regarding referrals to other users 108 for extending the user's indirect contribution to the charitable cause. In an exemplary embodiment, the computing platform may encourage the user 108 to refer at least two other users 108 to at least match the user's donation to the charitable cause. The user 108 may, using the input device 206 interfaced with their computing device 102a, input information regarding referrals to other users, such as telephone numbers, e-mail addresses, or other contact information for referred users 108. The computing device 102a may receive the data and, in step 312, the transmitting device 224 thereof may electronically transmit referral messages to the referral devices 102b using the received contact information.

In step 314, the receiving device 202 of the referral devices 102b may receive the referrals from the initial user's computing device 120a. The referral data may include at least the unique identifier for the user 108 and/or computing device 102a, the charitable cause that the user 108 donated to, and the donation amount made by the user 108. In step 316, the referral devices 102b may prompt their own users 108 (e.g., via display devices 208 interfaced therewith) to make donations at least matching the initial user's donation to the charitable cause. The users 108 may select donation amounts, provide payment information, and submit the donations to the processing server 110 using the transmitting device 224 of their respective referral device 102b. In step 320, the processing server 110 may receive the donation information for the referred donations, which include the charitable cause, donation amount, referral information for the initial user 108, and the unique identifier for each of the referred users 108. In step 322, the processing server 110 may process the donation, such as by submitting the payment information to a suitable financial service for payment to the charitable organization 104 indicated by the selected charitable cause, and may store information regarding the user's donation as well as the attribution of the donations to the initial user 108 as a result of the referral.

In step 324, the transmitting device 224 of the initial user's computing device 102a may electronically transmit a request for contribution data to the processing server 110 using a suitable communication network and method, such as via an application programming interface accessible by the computing platform on the computing device 102a. In step 326, the processing server 102 may receive the contribution data request, which may include at least the user's and/or computing device's unique identifier, and may also include the identifier for a charitable cause for which the user 108 wants to view their contribution. In step 328, the processing server 110 may identify the contribution data for the user 108 by identifying all of the data associated with the user's own contribution, identified via their unique identifier, as well as every indirect contribution made as a result of the user's referrals, also identified using the unique identifier, where all further referrals made as a result of the user's referrals will also be considered as attributable to the user 108. In step 330, the processing server 110 may transmit the identified contribution data to the computing device 102a.

In step 332, the receiving device 202 of the computing device 102a may receive the identified contribution data. The contribution data may include at least the user's own contribution, as well as the referred contribution amount resulting from the direct and indirect referrals made by the user 108, such as to the referral devices 102b and any subsequent referrals therefrom. In some cases, the contribution data may also include a contribution level determined based on the user's total contribution amount, the overall contribution amount for the charitable cause, the charitable organization's criteria, etc. In step 334, the generation module 220 of the computing device 102 may generate a graphical illustration of the user's contribution as a visual representation of their participation in fundraising for the charitable cause. The illustration may represent the user's overall contribution as a result of their referrals, and may be further based on their contribution level. In some cases, the illustration may be an animation, such as of a tree that grows larger and larger based on the increased contributions received attributable to the user 108. In step 336, the display device 208 interfaced with the computing device 102a may display the visual representation to the user 108.

### Exemplary Method for Gamification of Charitable Contributions

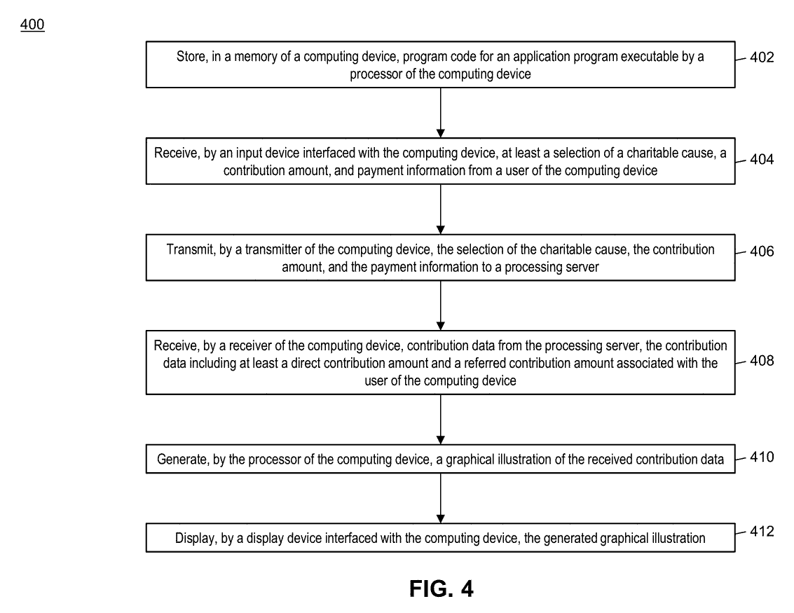

FIG. 4 illustrates a method 400 for the gamification of charitable contributions received in a computing platform through the use of a graphical illustration based on direct and indirect contributions attributable to a user of the computing platform.

In step 402, program code (e.g., program code 228) for an application program may be stored in a memory (e.g., the memory 226) of a computing device (e.g., the computing device 102) executable by a processor of the computing device. In step 404, at least a selection of a charitable cause, a contribution amount, and payment information may be received by an input device (e.g., the input device 206) interfaced with the computing device from a user (e.g., a user 108) of the computing device. In step 406, the selection of the charitable cause, the contribution amount, and the payment information may be transmitted by a transmitter (e.g., the transmitting device 224) of the computing device to a processing server (e.g., the processing server 110).

In step 408, contribution data may be received from the processing server by a receiver (e.g., the receiving device 202) of the computing device, the contribution data including at least a direct contribution amount and a referred contribution amount associated with the user of the computing device. In step 410, a graphical illustration may be generated by the processor (e.g., the generation module 220) of the computing device of the received contribution data. In step 412, the generated graphical illustration may be displayed by a display device (e.g., display device 208) interfaced with the computing device.

In one embodiment, the contribution data may further include at least one of: a number of contributors, a number of contributed causes, a contribution amount for each of a plurality of referral levels, a team contribution amount, and a number of team members. In some embodiments, the method 400 may also include: receiving, by the receiver of the computing device, a reward for the user of the computing device; and displaying, by the display device interfaced with the computing device, the received reward. In a further embodiment, the reward may be based on a combination of the direct contribution amount and the referred contribution amount.

In one embodiment, the method 400 may further include determining, by the processor (e.g., the determination module 222) of the computing device, a contribution level for the user of the computing device based on at least the contribution amount, the referred contribution amount, and a total contribution amount for the charitable cause. In a further embodiment, the contribution data may further include the total contribution amount. In another further embodiment, the graphical illustration may illustrate the determined contribution level. In yet another further embodiment, the graphical illustration may be an animated tree that grows based on the contribution amount, the referred contribution amount, and the determined contribution level.

### Computer System Architecture

FIG. 5 illustrates a computer system 500 in which embodiments of the present disclosure, or portions thereof, may be implemented as computer-readable code. For example, the computing device 102 and processing server 110 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for gamification of charitable contributions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for gamification of charitable contributions on a computing platform, comprising:
storing, in a memory of a computing device, program code for an application program executable by a processor of the computing device;
receiving, by an input device interfaced with the computing device, at least a selection of a charitable cause, a contribution amount, and payment information from a user of the computing device;
transmitting, by a transmitter of the computing device, the selection of the charitable cause, the contribution amount, and the payment information to a processing server;
receiving, by a receiver of the computing device, contribution data from the processing server, the contribution data including at least a direct contribution amount and a referred contribution amount associated with the user of the computing device;
generating, by the processor of the computing device, a graphical illustration of the received contribution data; and
displaying, by a display device interfaced with the computing device, the generated graphical illustration.

2. The method of claim 1, wherein the contribution data further includes at least one of: a number of contributors, a number of contributed causes, a contribution amount for each of a plurality of referral levels, a team contribution amount, and a number of team members.

3. The method of claim 1, further comprising:
determining, by the processor of the computing device, a contribution level for the user of the computing device based on at least the contribution amount, the referred contribution amount, and a total contribution amount for the charitable cause.

4. The method of claim 3, wherein the contribution data further includes the total contribution amount.

5. The method of claim 3, wherein the graphical illustration illustrates the determined contribution level.

6. The method of claim 3, wherein the graphical illustration is an animated tree that grows based on the contribution amount, the referred contribution amount, and the determined contribution level.

7. The method of claim 1, further comprising:
receiving, by the receiver of the computing device, a reward for the user of the computing device; and
displaying, by the display device interfaced with the computing device, the received reward.

8. The method of claim 7, wherein the reward is based on a combination of the direct contribution amount and the referred contribution amount.

9. A non-transitory computer readable media in a computing device configured to store program code executable by a processor of the computing device, wherein execution of the program code by the processor causes the computing device to perform a method for gamification of charitable contributions, the method comprising:
receiving, by an input device interfaced with the computing device, at least a selection of a charitable cause, a contribution amount, and payment information from a user of the computing device;
transmitting, by a transmitter of the computing device, the selection of the charitable cause, the contribution amount, and the payment information to a processing server;
receiving, by a receiver of the computing device, contribution data from the processing server, the contribution data including at least a direct contribution amount and a referred contribution amount associated with the user of the computing device;
generating, by the processor of the computing device, a graphical illustration of the received contribution data; and
displaying, by a display device interfaced with the computing device, the generated graphical illustration.

10. The non-transitory computer readable media of claim 9, wherein the contribution data further includes at least one of: a number of contributors, a number of contributed causes, a contribution amount for each of a plurality of referral levels, a team contribution amount, and a number of team members.

11. The non-transitory computer readable media of claim 9, wherein the method further comprises:
determining, by the processor of the computing device, a contribution level for the user of the computing device based on at least the contribution amount, the referred contribution amount, and a total contribution amount for the charitable cause.

12. The non-transitory computer readable media of claim 11, wherein the contribution data further includes the total contribution amount.

13. The non-transitory computer readable media of claim 11, wherein the graphical illustration illustrates the determined contribution level.

14. The non-transitory computer readable media of claim 11, wherein the graphical illustration is an animated tree that grows based on the contribution amount, the referred contribution amount, and the determined contribution level.

15. The non-transitory computer readable media of claim 9, wherein the method further comprises:
receiving, by the receiver of the computing device, a reward for the user of the computing device; and
displaying, by the display device interfaced with the computing device, the received reward.

16. The non-transitory computer readable media of claim 15, wherein the reward is based on a combination of the direct contribution amount and the referred contribution amount.
